(19) United States
(12) Patent Application Publication
(10) Pub. No.: US 2023/0033944 A1
(43) Pub. Date: Feb. 2, 2023

(54) INTEGRATED CORAL CULTIVATION SYSTEM

(71) Applicant: NATIONAL MUSEUM OF MARINE BIOLOGY AND AQUARIUM, Pingtung County (TW)

(72) Inventors: Shao-En PENG, Kaohsiung City (TW); Yu-Min CHU, Kaohsiung City (TW); Chii-Shiarng CHEN, Kaohsiung City (TW)

(21) Appl. No.: 17/873,401

(22) Filed: Jul. 26, 2022

(30) Foreign Application Priority Data
Jul. 30, 2021 (TW) 110128101

(51) Int. Cl. A01K 61/20; A01K 63/04; A01K 63/06; A47B 57/30

(52) U.S. Cl. CPC A01K 61/20; A01K 63/042; A01K 63/065; A47B 57/30; A47B 2200/14

(57) ABSTRACT

An integrated coral cultivation system includes a water tank unit having at least one aquaculture tank configured to contain corals, a water supply unit for supplying aquaculture water to the water tank unit, a drain unit for discharging the aquaculture water in the water supply unit and the aquaculture tank to the outside, an air supply unit for supplying air to the water tank unit, a temperature adjustment unit for adjusting the temperature of the aquaculture water in the water tank unit, a light unit for providing lighting to the water tank unit, and a power source unit for supplying power to the water supply unit, the air supply unit, the temperature adjustment unit and the light unit.

### CROSS-REFERENCE TO RELATED APPLICATION

This application claims priority to Taiwanese Patent Application No. 110128101, filed on Jul. 30, 2021.

### FIELD

The disclosure relates to a cultivation device, more particularly to an integrated coral cultivation system.

### BACKGROUND

Coral is a narrowly adapted marine animal that has very strict requirements for the quality of the environment in which it lives, and is extremely sensitive to changes in environmental conditions. Therefore, in order to successfully cultivate corals, it is necessary to strictly control environmental conditions, such as water temperature, oxygen content, water quality, and light, so as to create or maintain an environment suitable for coral growth for a long time. Although there are a variety of coral cultivation equipment, and the technology of artificial coral cultivation is developing rapidly, various cultivating conditions are being optimized and upgraded, it is inevitable to continuously add additional digital monitoring or environmental control devices, and even constantly change the design of the aquaculture tank. Thus, in response to the aforementioned changes and needs, it is indeed necessary to improve the existing cultivating equipment.

### SUMMARY

Therefore, an object of the present disclosure is to provide an integrated coral cultivation system that can facilitate creation or adjustment of environmental conditions for cultivating corals.

According to this disclosure, an integrated coral cultivation system comprises a shelf unit, a water tank unit, a water supply unit, a drain unit, an air supply unit, a temperature adjustment unit, a light unit, and a power source unit. The shelf unit defines a plurality of receiving spaces spaced apart from each other in a top-bottom direction or a height direction of the shelf unit. The water tank unit is disposed on the shelf unit, and includes at least one aquaculture tank disposed in one of the receiving spaces and configured to contain corals. The water supply unit is disposed on the shelf unit, communicates with the water tank unit, and is configured to supply aquaculture water to the water tank unit.

The drain unit is disposed on the shelf unit, communicates with the water tank unit and the water supply unit, and includes at least one water collecting pipe communicating with the at least one aquaculture tank, an overflow pipe connected between the at least one water collecting pipe and the water supply unit, and a drain pipe communicating with the at least one water collecting pipe and configured to discharge the aquaculture water to the outside.

The air supply unit communicates with the water tank unit and is configured to supply air to the water tank unit. The temperature adjustment unit communicates with the water tank unit and is configured to adjust the temperature of the aquaculture water in the water tank unit. The light unit includes a plurality of light sources disposed on top sides of the receiving spaces and configured to provide lighting to the water tank unit. The power source unit is disposed on the shelf unit and is configured to supply power to the water supply unit, the air supply unit, the temperature adjustment unit and the light unit.

### BRIEF DESCRIPTION OF THE DRAWINGS

Other features and advantages of the disclosure will become apparent in the following detailed description of the embodiment with reference to the accompanying drawings, of which:

FIG. 1 is an incomplete perspective view of an integrated coral cultivation system according to an embodiment of the present disclosure;

FIG. 2 is a perspective view of a main frame of a shelf unit of the embodiment;

FIG. 3 is a perspective view of the shelf unit of the embodiment, but without carrier platforms of bracket assemblies of the shelf unit;

FIG. 4 is a fragmentary perspective view of the embodiment, illustrating a top portion of the main frame and one of the bracket assemblies of the shelf unit;

FIG. 5 is a fragmentary perspective view, illustrating a water supply unit of the embodiment, but without water supply pipes and water supply valves thereof; and

FIG. 6 is a perspective view of another implementation of the embodiment.

### DETAILED DESCRIPTION

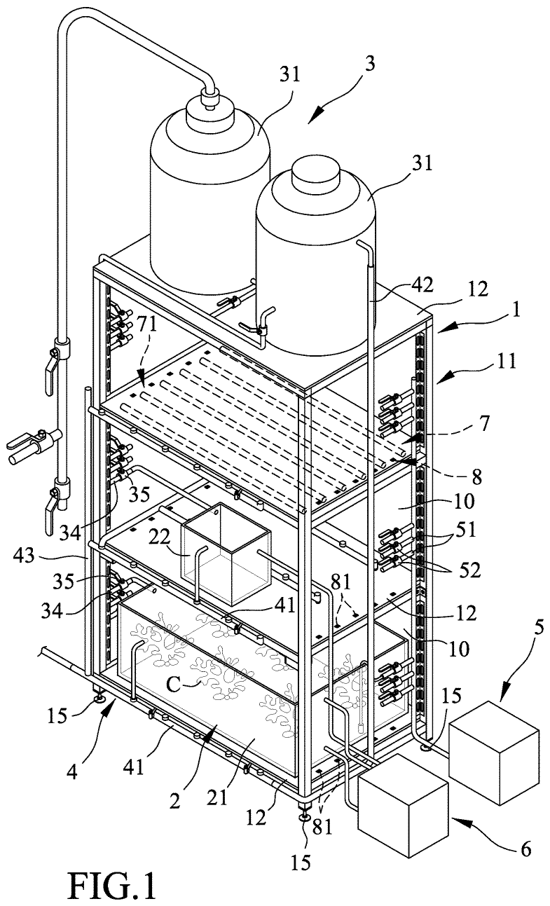

Referring to FIGS. 1 to 5, an integrated coral cultivation system according to an embodiment of the present disclosure is suitable for cultivating corals (C), and includes a shelf unit 1, a water tank unit 2, a water supply unit 3, a drain unit 4, an air supply unit 5, a temperature adjustment unit 6, a light unit 7, and a power source unit 8.

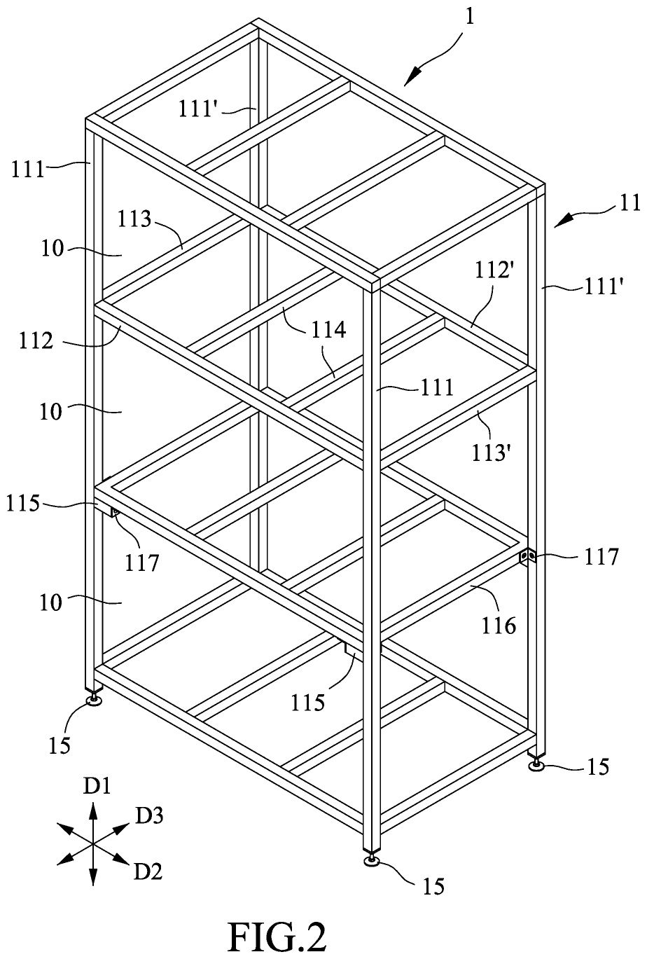

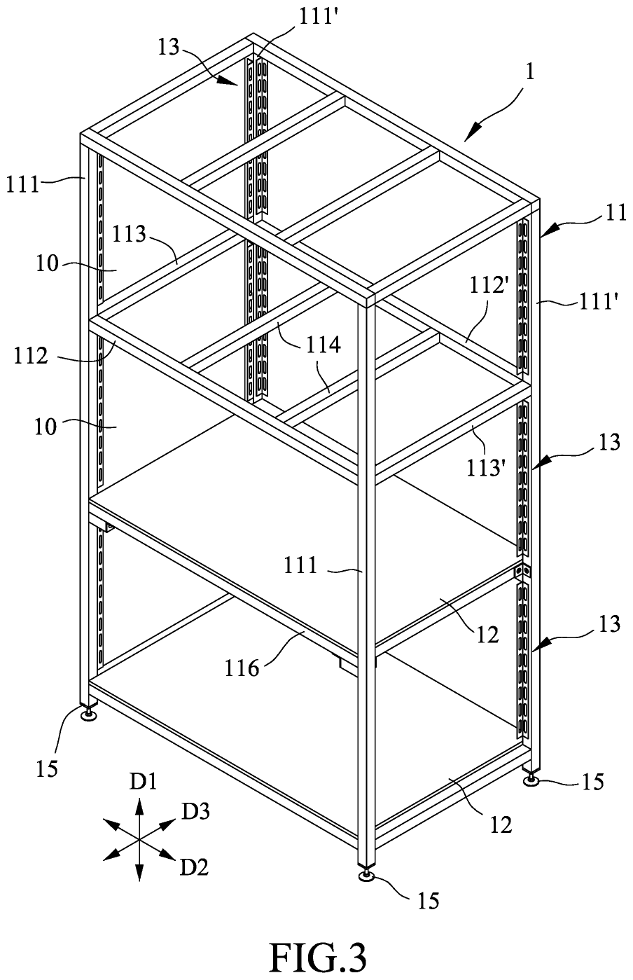

The shelf unit 1 includes a main frame 11 defining a plurality of receiving spaces 10 spaced apart from each other in a top-bottom direction or a height direction (D1) of the shelf unit 1, a plurality of shelf panels 12 respectively disposed in the receiving spaces 10, a plurality of bracket assemblies 13 mounted on the main frame 11 and respectively located in the receiving spaces 10, and four adjustment members 15 (only three are visible in FIGS. 1 to 3) spaced apart from each other and connected to a bottom side of the main frame 11 for rotating and adjusting a horizontal state of the main frame 11. It should be noted herein that to clearly illustrate the structure of the main frame 11, only the main frame 11 and the adjustment members 15 are shown in FIG. 2, and only the shelf unit 1 with some components of the bracket assemblies 13 is shown in FIG. 3.

With reference to FIG. 2, the main frame 11 includes two front vertical rods 111 extending in the height direction (D1) and spaced apart from each other in a length direction (D2) of the shelf unit 1, two rear vertical rods 111′ extending in the height direction (D1) and opposite to the front vertical rods 111 in a width direction (D3) of the shelf unit 1, a plurality of spaced-apart front horizontal rods 112 extending in the length direction

(D2) and connected between the front vertical rods 111, a plurality of spaced-apart rear horizontal rods 112′ extending in the length direction (D2) and connected between the rear vertical rods 111′, a plurality of left outer connecting rods 113 extending in the width direction (D3) and connected between one of the front vertical rods 111 and a corresponding one of the rear vertical rods 111′, a plurality of right outer connecting rods 113′ extending in the width direction (D3) and connected between the other front vertical rod 111 and a corresponding other rear vertical rod 111′, a plurality of inner connecting rods 114 extending in the width direction (D3), four L-shaped support members 115 respectively protruding from the front and rear vertical rods 111, 111′ into one of the receiving spaces 10, a detachable frame member 116 detachably supported on the L-shaped support members 115, and a plurality of L-shaped positioning members 117 for positioning the frame member 116.

In this embodiment, the adjustment members 15 are respectively connected to bottom ends of the front and rear vertical rods 111, 111′, and each two of the inner connecting rods 114 are connected between one of the front horizontal rods 112 and a corresponding one of the rear horizontal rods 112′. Further, each front horizontal rod 112, each rear horizontal rod 112′, each left outer connecting rod 113 and each right outer connecting rod 113′ cooperatively form a fixed frame member of the main frame 11. Thus, three fixed frame members are formed by the cooperation of the front horizontal rods 112, the rear horizontal rods 112′, the left outer connecting rods 113 and the right outer connecting rods 113′, and are spaced apart from each other in the height direction (D1). The detachable frame member 116 is located above the lowest one of the fixed frame members. One of the shelf panels 12 is mounted on the detachable frame member 116, while each of the remaining shelf panels 12 is mounted on a corresponding one of the fixed frame members.

Each of some of the L-shaped positioning members 117 has two sides respectively secured to the detachable frame member 116 and a corresponding one of the front and rear vertical rods 111, 111′, while each of the other remaining L-shaped positioning members 117 has two sides respectively secured to the detachable frame member 116 and a corresponding one of the support members 115.

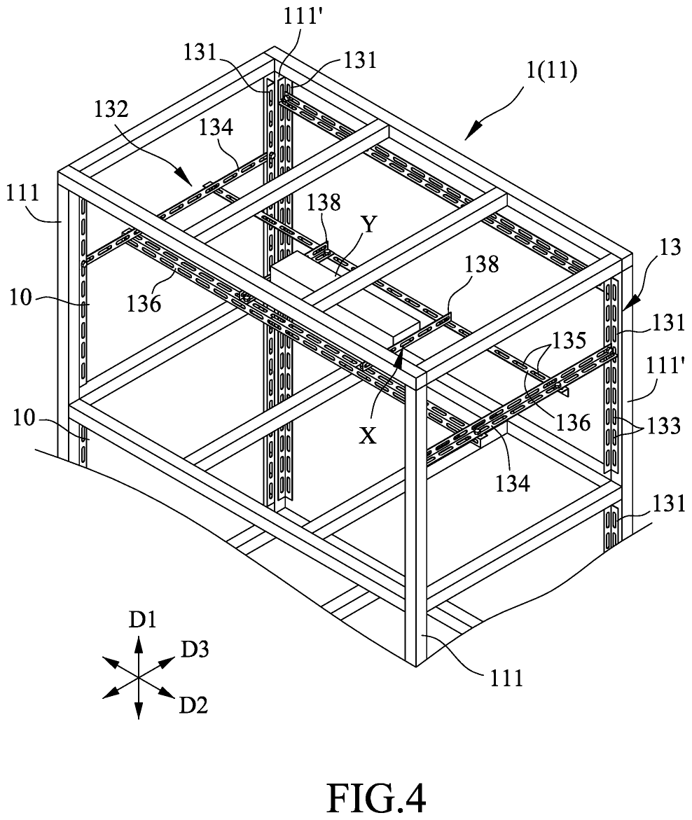

To clearly illustrate the structure of the shelf unit 1, only a top portion of the main frame 11 and one of the bracket assemblies 13 of the shelf unit 1 are illustrated in FIG. 4, while the support members 115, the detachable frame member 116, the positioning members 117, the shelf panels 12 and the adjustment members 15 are omitted herein. Since the structure of each bracket assembly 13 is similar, only one bracket assembly 13 will be described in detail hereinafter. The bracket assembly 13 includes a plurality of L-shaped fixed brackets 131 extending in the height direction (D1) and respectively positioned on the front and rear vertical rods 111, 111′, and a carrier platform 132 mounted to the L-shaped fixed brackets 131 in a position-adjustable manner along the lengths thereof.

Each L-shaped fixed bracket 131 has a plurality of through holes 133 spacedly arranged along the length thereof and communicating with a corresponding one of the receiving spaces 10 and the outside. The carrier platform 132 includes two first movable brackets 134 each of which is adjustably connected between two adjacent ones of the L-shaped fixed brackets 131 which are respectively positioned on one of the front vertical rods 111 and a corresponding rear vertical rod 111′, two second movable brackets 136 adjustably connected between the first movable brackets 134, and two third movable brackets 138 adjustably connected between the second movable brackets 136. Each of the first to third movable brackets 134, 136, 138 is L-shaped, and has a plurality of apertures 135 spacedly arranged along a length thereof.

In this embodiment, a plurality of fastening components, such as bolts and nuts (only some bolts are visible in FIG. 4), are used to fasten the first to third movable brackets 134, 136, 138 together. Furthermore, by using the first to third movable brackets 134, 136, 138 of different sizes, the first and second movable brackets 134, 136 can overlap each other, and the second and third movable brackets 136, 138 can overlap each other. Through this configuration, the first to third movable brackets 134, 136, 138 can cooperate to form a platform (X) for mounting of an auxiliary equipment (Y), such as a special light, a feeder, a water quality detector, a camera, etc.

Moreover, the size and the position of the platform (X) can be adjusted according to different types or sizes of the auxiliary equipment (Y). For example, by first loosening the bolts and nuts that fasten the third movable brackets 138 to the second movable brackets 136 and that fasten the second movable brackets 136 to the first movable brackets 134, the third movable brackets 138 can be moved toward or away from each other to an appropriate distance along the length direction (D2), and the second movable brackets 136 can also be moved toward or away from each other to an appropriate distance along the width direction (D3), after which the bolts and nuts are tightened to fix the third movable brackets 138 and the second movable brackets 136 to their respective desired positions. Thereafter, the bolts and nuts fixing the first movable brackets 134 to the L-shaped fixed brackets 131 are loosened to allow the first movable brackets 134 to move relative to the L-shaped fixed brackets 131 to a desired height along the height direction (D1), after which the bolts and nuts are tightened to fix the first movable brackets 134 to the desired height. Thus, the size and the position of the platform (X) in the corresponding receiving space 10 can be adjusted by adjusting the position of each of the first to third movable brackets 134, 136, 138 to suit the requirements.

In this embodiment, the water tank unit 2 includes an aquaculture tank 21 that is disposed on and supported by one of the shelf panels 12 placed on one of the fixed frame members located on the lowest level of the shelf unit 1 and that is configured to contain corals (C), and a production tank 22 that is disposed on and supported by another one of the shelf panels 12 placed on the detachable frame member 116 and that is configured to raise to-be-produced corals (C).

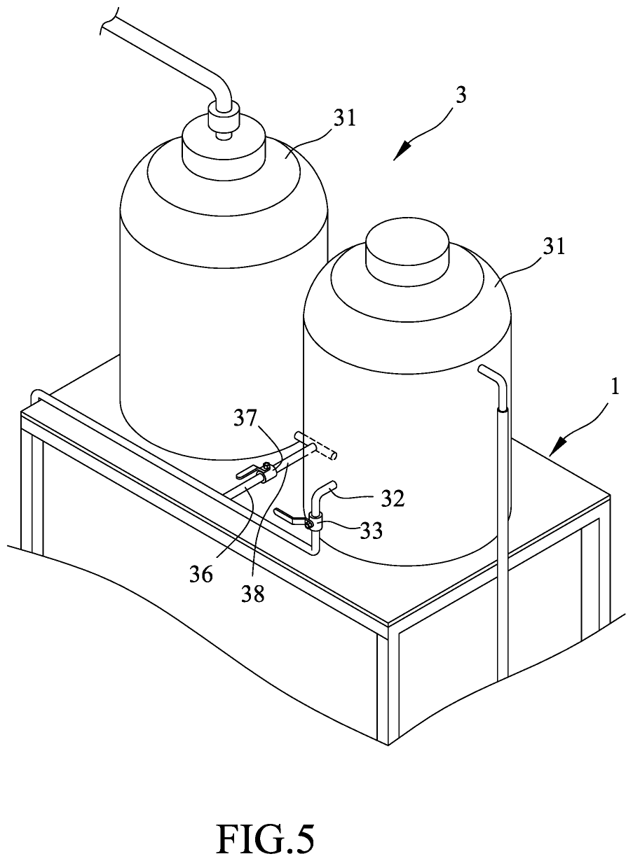

With reference to FIGS. 1 and 5, the water supply unit 3 communicates with the water tank unit 2, and is configured to supply aquaculture water to the water tank unit 2. In this embodiment, the water supply unit 3 includes two water storage tanks 31 that are mounted on a third one of the shelf panels 12 placed on a top side of the main frame 11 and that are suitable for storing the aquaculture water, a water outlet pipe 32 connected to and extending out from one of the water storage tanks 31, a water outlet valve 33 communicating with the water outlet pipe 32 and being operable for controlling the flow of the aquaculture water from the water outlet pipe 32, a plurality of water supply pipes 34 for communicating the water outlet pipe 32 with the aquaculture tank 21 and the production tank 22, a plurality of water supply valves 35 respectively communicating with the water supply pipes 34 and being operable to control the flow of the aquaculture water from the respective water supply pipes 34, a T-shaped connecting pipe 38 interconnecting the water storage tanks 31 and located on bottom ends thereof, a backup water pipe 36 connected between the T-shaped connecting pipe 38 and the water outlet pipe 32 for communicating with the water storage tanks 31 and the water outlet pipe 32, and a backup water valve 37 for openably closing the backup water pipe 36. The other one of the water storage tanks 31 is configured to be connected to an external water source.

In this embodiment, the amount of aquaculture water that can be stored by the water storage tanks 31 is more than 50% of the volume of the water tank unit 2, and the water outlet pipe 32 is connected to one-third of the height of one of the water storage tanks 31. Further, each of the water supply pipes 34 is directly connected to a corresponding one of the aquaculture tank 21 and the production tank 22. However, each water supply pipe 34 may be connected to the corresponding one of the aquaculture tank 21 and the production tank 22 using a water pipe in accordance with the disposition of the aquaculture tank 21 and the production tank 22.

In other implementations of this embodiment, the water supply unit 3 may further include a blending tank (not shown) communicating with the water storage tanks 31 for adjusting the salinity of the aquaculture water, a filter (not shown) having a plurality of filter holes arranged from largest to smallest diameters, and an ultraviolet (UV) germicidal lamp (not shown). Through these additional components, the aquaculture water that has been blended, filtered and sterilized can be stored in the water storage tanks 31 and can be supplied to the aquaculture tank 21 and the production tank 22 so as to ensure the quality of the aquaculture water and make the living environment of the corals (C) more stable.

The drain unit 4 communicates with the water supply unit 3 and the water tank unit 2, and is suitable for discharging the aquaculture water in the water supply unit 3 and the water tank unit 2. The drain unit 4 includes a plurality of water collecting pipes 41 correspondingly communicating with the aquaculture tank 21 and the production tank 22, an overflow pipe 42 connected between one of the water storage tanks 31 and one of the water collecting pipes 41, and a drain pipe 43 communicating with the water collecting pipes 41 for discharging the aquaculture water to the outside.

The air supply unit 5 communicates with the water tank unit 2, and is configured to supply air to the water tank unit 2. The air supply unit 5 includes an air supply pump (not shown) communicating with the water tank unit 2, a backup air supply pump (not shown) disposed in parallel with the air supply pump, a plurality of air supply pipes 51 for communicating the air supply pump with the aquaculture tank 21 and the production tank 22, and a plurality of air valves 52 respectively communicating with the air supply pipes 51 and being operable to adjust air flow. Through this, when the air supply pump fails to function, the backup air supply pump can be immediately started to continue supply of air so as to ensure that the corals (C) have enough oxygen to use. When using this embodiment, the air supply pipes 51 can be connected to the aquaculture tank 21 and the production tank 22 using air communicating pipes in accordance with the disposition of the aquaculture tank 21 and the production tank 22, and one or more air bubble stones (not shown) can be installed at the ends of the air supply pipes 51 or the air communicating pipes according to the use requirements so as to increase the dissolved oxygen content of the aquaculture water. The air supply pipes 51 can guide air supplied by the air supply pump into the aquaculture tank 21 and the production tank 22, and in coordination with the air valves 52 to control the flow of air into the aquaculture tank 21 and the production tank 22, air intake into the aquaculture tank 21 and the production tank 22 can be independently controlled.

The temperature adjustment unit 6 communicates with the water tank unit 2, and is configured to adjust the temperature of the aquaculture water in the water tank unit 2. In this embodiment, a circulating pump (not shown) is used to pump the aquaculture water from the water tank unit 2, and input it into a heat exchanger (not shown) for heating or cooling, and then return the aquaculture water to the water tank unit 2. In addition to individually adjusting the temperature of the aquaculture water in the aquaculture tank 21 and the production tank 22, the temperature of the aquaculture water can also be kept constant, so that the growth environment of the corals (C) can be more stable.

The light unit 7 includes a plurality of light sources 71 correspondingly disposed on top sides of the receiving spaces 10 and configured to provide lighting to the water tank unit 2. In this embodiment, each light source 71 includes a pair of LED T5 fluorescent tubes, and three light sources 71 are arranged alternately on the top side of the corresponding receiving space 10. At least two of the light sources 71 have different wave-lengths for providing the corals (C) with light of different wavelengths. However, in other implementations of this embodiment, the light unit 7 may further include a plurality of switches (not shown) and a plurality of timers (not shown) correspondingly connected to the light sources 71. The switches may be manually operated and the timers may be set for automatically adjusting the length of illumination of the light sources 71 according to the species of the corals (C) in the aquaculture tank 21 and the production tank 22.

The power source unit 8 is configured to supply power to the water supply unit 3, the air supply unit 5, the temperature adjustment unit 6 and the light unit 7. Further, the power source unit 8 is also suitable for supplying power to the auxiliary equipment (Y), and has a safety design that can carry large current, prevent leakage and prevent static electricity. Since the aforementioned safety design of the power source unit 8 is well known to those skilled in the art, a detailed description thereof will be omitted herein. In this embodiment, the power source unit 8 includes a plurality of sockets 81 embedded in the shelf panels 12 for electrical connection of the equipment installed in the receiving spaces 10 to provide the required power. The sockets 81 are embedded in bottom sides of the shelf panels 12 for preventing electric shock caused by the overflow of the aquaculture water.

With reference to FIG. 2, prior to mounting of the water tank unit 2 (see FIG. 1) and the other equipment on the shelf unit 1, the adjustment members 15 are first rotated to adjust a horizontal state of the main frame 11, after which, according to the use requirements, the detachable frame member 116 is mounted on the support members 115, and some of the positioning members 117 are fastened to the detachable frame member 116 and the front and rear vertical rods 111, 111′, while the other positioning members 117 are fastened to the detachable frame member 116 and the support members 115, by using a plurality of bolts and nuts to stably position the detachable frame member 116, so that the detachable frame member 116 is prevented from slipping off the support members 115.

Next, with reference to FIG. 3, one of the shelf panels 12 is mounted on the detachable frame member 116, while each of the remaining shelf panels 12 (only one is shown) is mounted on a respective one of the fixed frame members cooperatively formed by each front horizontal rod 112, each rear horizontal rod 112′, each left outer connecting rod 113 and each right outer connecting rod 113′. The assembly of the main frame 11 and the shelf panels 12 is thus completed. Through the arrangement of the left and right outer connecting rods 113, 113′ and the inner connecting rod 114, the structural stability of the main frame 11 can be enhanced, and the maximum bearing capacity of the main frame 11 can be increased.

Afterwards, the bracket assemblies 13 (only one is shown in FIG. 4) are installed on the front and rear vertical rods 111, 111′ according to the use requirements for mounting of the auxiliary equipment (Y), for example, a special lighting. If there is no need to mount the auxiliary equipment (Y), the carrier platform 132 can be removed from the corresponding L-shaped fixed brackets 131, so that a usable space of each receiving space 10 can be vacated to provide a higher flexibility of space utilization. Moreover, since each L-shaped fixed bracket 131 has the through holes 133 spacedly arranged along the length thereof or along the height direction (D1), and each of the first to third movable brackets 134, 136, 138 has the apertures 135 spacedly arranged along the length thereof, the first movable brackets 134 can be allowed to move relative to the L-shaped fixed brackets 131 to a desired position along the height direction (D1), the second movable brackets 136 can be allowed to move relative to the first movable brackets 134 to a desired position along the width direction (D3), and the third movable brackets 138 can be allowed to move relative to the second movable brackets 136 to a desired position along the length direction (D2) according to the size or height of the auxiliary equipment (Y) to be mounted in the corresponding receiving space 10.

Referring back to FIGS. 1 and 4, in this embodiment, when the carrier platform 132 of each bracket assembly 13 (only one carrier platform 132 is shown in FIG. 4) is mounted with the auxiliary equipment (Y), by adjusting the relative heights between the carrier platform 132 and the L-shaped fixed brackets 131, the distance between the auxiliary equipment (Y) and the aquaculture tank 21 or between the auxiliary equipment (Y) and the production tank 22 can be adjusted, thereby adjusting the illuminance of the auxiliary equipment (Y) if it is a special lighting. In other implementations of this embodiment, an existing fiberglass reinforced plastic drum (not shown) may also be mounted on the shelf panel 12 that is located on the lowest level of the shelf unit 1, and the detachable frame member 116 and the positioning members 117 may be removed to match the height of the fiberglass reinforced plastic drum, so that this embodiment can be used with devices of various sizes and has high versatility.

Through the structural design of the shelf unit 1, the shelf panels 12, the carrier platform 132 and the detachable frame member 116 can be removed, so that the mounting method of the shelf unit 1 is more flexible, and can flexibly meet the configuration requirements of the water tank unit 2 and the other equipment, and can adapt to the space requirements of various aquaculture sites.

Referring again to FIGS. 1 and 5, when this embodiment is actually used for raising the corals (C), under normal use conditions, the water outlet valve 33 will remain open, while the backup water valve 37 will remain closed, and the corresponding water supply valves 35 are open according to the use requirements. Through the design of the water supply unit 3, the aquaculture water will naturally flow from the water storage tanks 31 located at the top side of the main frame 11 to the water outlet pipe 32 by gravity, and down along the water supply pipes 34 into the aquaculture tank 21 and the production tank 22, so that the purpose of saving electricity and reducing the power load can be achieved.

Additionally, the water storage tanks 31 of this embodiment can store a sufficient amount of the aquaculture water, and the water supply pipes 34 can be used to guide the aquaculture water into the aquaculture tank 21 and the production tank 22, and in coordination with the water supply valves 35 to control the flow of the aquaculture water into the aquaculture tank 21 and the production tank 22, apart from being able to independently control the water intake into the aquaculture tank 21 and the production tank 22, water contamination and disease transmission can also be effectively prevented. Through the design of the height position of the water outlet pipe 32, an appropriate amount of aquaculture water can be stored, and in coordination with the provision of the backup water pipe 36 and the backup water valve 37, the backup water valve 37 can be opened during the water outage to use the stored aquaculture water in the water storage tanks 31.

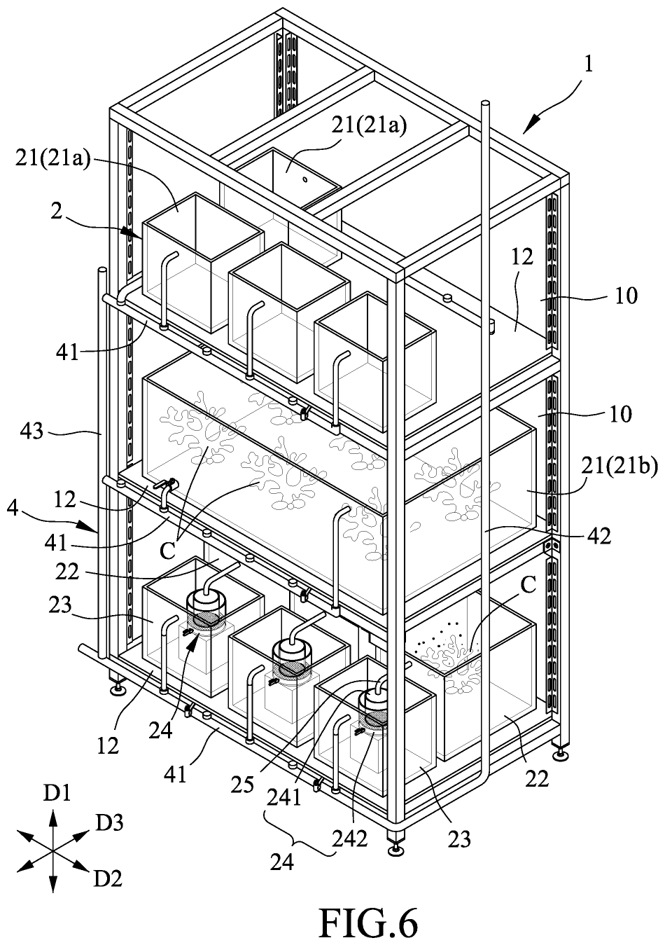

FIG. 6 illustrates another implementation of the embodiment, and for clarity of the description thereof, the water supply unit 3, the air supply unit 5, the temperature adjustment unit 6 and the light unit 7 are not shown herein. As shown in FIG. 6, the water tank unit 2 includes a plurality of the aquaculture tanks 21, a plurality of the production tanks 22, a plurality of overflow tanks 23, and a plurality of egg collecting devices 24. The aquaculture tanks 21, the production tanks 22, and the overflow tanks 23 are disposed on and supported by the shelf panels 12 placed on different levels of the shelf unit 1.

With reference to FIG. 6, for the convenience of description, the aquaculture tanks 21 located at the highest level of the shelf unit 1 are labeled as (21a), while the aquaculture tank 21 located at a level immediately below the highest level of the shelf unit 1 is labeled as (21b). When using this embodiment, the water tank unit 2 can be mounted on the shelf panels 12 according to the raising requirements. For example, a plurality of smaller size aquaculture tanks (21a) are disposed independent of each other on the shelf panel 12 that is located at the highest level of the shelf unit 1 for individual cultivation of ramets or test use thereof, and a larger size aquaculture tank (21b) is mounted on the shelf panel 12 that is located at the level immediately below the highest level of the shelf unit 1 for cultivating larger corals (C) or multiple corals (C) at the same time.

The production tanks 22 are disposed on the shelf panel 12 that is located at the lowest level of the shelf unit 1 for individually raising the to-be-produced corals (C). The overflow tanks 23 are disposed on the same level as the production tanks 22, and are located forwardly of the production tanks 22. Each overflow tank 23 has a height lower than that of each production tank 22. The overflow tanks 23 communicate with the water collecting pipe 41 that is connected to the overflow pipe 42 for discharging the aquaculture water therein to the outside through the drain pipe 43.

The egg collecting devices 24 are respectively accommodated in the overflow tanks 23. Each of the egg collecting devices 24 communicates with a respective one of the production tanks 22 through a communicating pipe 25, and is configured to receive the aquaculture water overflowing from the respective production tank 22. Each egg collecting device 24 includes an egg collecting member 241 provided with a 120 mesh filter screen at a bottom side thereof, and a buffer member 242 receiving and surrounding the egg collecting member 241 and provided with a 56 mesh filter screen at a position proximate to a bottom side thereof. The filter screen of the egg collecting member 241 is stacked on top of the filter screen of the buffer member 242.

The aquaculture water in the aquaculture tanks (21a, 21b) and the overflow tanks 23 can flow into the drain pipe 43 through the corresponding water collecting pipes 41, and discharge therefrom. Overflow water in the water storage tanks 31 can flow into the drain pipe 43 through the overflow pipe 42 and the water collecting pipe 41 connected thereto, and discharge therefrom for other usage.

Referring again to FIG. 6, since floating larvae and sperms and eggs of the corals (C) are suspended, the floating larvae and the sperms and the eggs produced by the corals (C) in each production tank 22 will first float on a top side of the aquaculture water therein, and then overflow into the respective egg collecting device 24. Since the volume of the sperms of the corals (C) is smaller than the hole diameter of the filter screens of the egg collecting member 241 and the buffer member 242 of the respective egg collective device 24, while the volume of the eggs and the floating larvae of the corals (C) are larger than the hole diameter of the filter screens of the egg collecting member 241 and the buffer member 242 of the respective egg collective device 24, when the sperms and the eggs and the floating larvae of the corals (C) follow the flow of the aquaculture water and enter the egg collecting member 241 of the respective egg collective device 24, the aquaculture water and the sperms will flow through the filter screens of the egg collecting member 241 and the buffer member 242 of the respective egg collective device 24 into the buffer member 242 thereof, and the eggs and the floating larvae will remain in the egg collecting member 241 of the respective egg collective device 24.

Through the structural design of the overflow tanks 23, the egg collecting members 241, and the buffer members 242, the sperms and the eggs and the floating larvae of the corals (C) can first be separated, after which it is only necessary to take out each egg collecting device 24 from the respective overflow tank 23, and then use a straw to suck the eggs and the floating larvae in the egg collecting member 241 or slowly lift the egg collecting member 241 of each egg collecting device 24, the eggs and the floating larvae of the corals (C) can thus be quickly obtained. Furthermore, the aquaculture water located on the top side of the buffer member 242 of each egg collecting device 24 can also be sucked using the straw to obtain the sperms of the corals (C) suspended on the top side of the aquaculture water. Thus, it is helpful for users to collect and improve the survival rate of the floating larvae and the sperms and the eggs of the corals (C).

With reference to FIGS. 1 and 6, it should be noted herein that the disposition of the aquaculture tank 21 and the production tank 22 of this embodiment may be as shown in FIG. 1, or the disposition of the aquaculture tanks 21, the production tanks 22, the overflow tanks 23 and the egg collecting devices 24 may be as shown in FIG. 6. However, in actual practice, the number and the disposition of the components of the water tank unit 2 are not limited to what is disclosed herein.

In summary, in the integrated coral cultivation system of this disclosure, the receiving spaces 10 of the shelf unit 1 are disposed spaced apart from each other in the top-bottom direction or the height direction (D1) of the shelf unit 1 to effectively increase the space utilization thereof; by mounting the water tank unit 2, the water supply unit 3, the drain unit 4, the air supply unit 5, the temperature control 6, the light unit 7 and the power source unit 8 on the shelf unit 1, the volume of the aquaculture water, the water temperature, the air and the light in the aquaculture tank(s) 21 and the production tank(s) 22 can be adjusted according to the environmental conditions required by the corals (C) which is beneficial to the growth of the corals (C). Therefore, the object of this disclosure can indeed be achieved.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. An integrated coral cultivation system comprising:
a shelf unit defining a plurality of receiving spaces spaced apart from each other in a top-bottom direction or a height direction of said shelf unit;
a water tank unit disposed on said shelf unit and including at least one aquaculture tank disposed in one of said receiving spaces and configured to contain corals;
a water supply unit disposed on said shelf unit and communicating with said water tank unit, said water supply unit being configured to supply aquaculture water to said water tank unit;
a drain unit disposed on said shelf unit and communicating with said water tank unit and said water supply unit, said drain unit including at least one water collecting pipe communicating with said at least one aquaculture tank, an overflow pipe connected between said at least one water collecting pipe and said water supply unit, and a drain pipe communicating with said at least one water collecting pipe and configured to discharge the aquaculture water to the outside;
an air supply unit communicating with said water tank unit and configured to supply air to said water tank unit;
a temperature adjustment unit communicating with said water tank unit and configured to adjust the temperature of the aquaculture water in said water tank unit;
a light unit including a plurality of light sources disposed on top sides of said receiving spaces and configured to provide lighting to said water tank unit; and
a power source unit disposed on said shelf unit and configured to supply power to said water supply unit, said air supply unit, said temperature adjustment unit and said light unit.

2. The integrated coral cultivation system as claimed in claim 1, wherein said shelf unit includes a main frame defining said receiving spaces, and a plurality of shelf panels respectively disposed in said receiving spaces, one of said shelf panels being configured to support said at least one aquaculture tank, said main frame including two front vertical rods extending in the height direction and spaced apart in a length direction of said shelf unit, two rear vertical rods extending in the height direction and opposite to said front vertical rods in a width direction of said shelf unit, a plurality of spaced-apart front horizontal rods extending in the length direction of said shelf unit and connected between said two front vertical rods, and a plurality of spaced-apart rear horizontal rods extending in the length direction and connected between said two rear vertical rods.

3. The integrated coral cultivation system as claimed in claim 2, wherein said shelf unit further includes a plurality of bracket assemblies mounted on said main frame and respectively located in said receiving spaces, each of said bracket assemblies including a plurality of fixed brackets extending in the height direction and respectively positioned on said front vertical rods and said rear vertical rods, and a carrier platform mounted to said fixed brackets in a position-adjustable manner along the lengths thereof.

4. The integrated coral cultivation system as claimed in claim 3, wherein said carrier platform includes two first movable brackets each of which is adjustably connected between two adjacent ones of said fixed brackets which are respectively positioned on one of said front vertical rods and a corresponding one of said rear vertical rods, two second movable brackets adjustably connected between said first movable brackets, and two third movable brackets adjustably connected between said second movable brackets.

5. The integrated coral cultivation system as claimed in claim 4, wherein each of said fixed brackets has a plurality of through holes spacedly arranged along the length thereof and communicating with a corresponding one of said receiving spaces and the outside, and each of said first to third movable brackets has a plurality of apertures spacedly arranged along a length of a corresponding one of said first to third movable brackets.

6. The integrated coral cultivation system as claimed in claim 2, wherein said main frame further includes four L-shaped support members respectively protruding from said front vertical rods and said rear vertical rods into one of said receiving spaces, a detachable frame member detachably supported on said support members, and a plurality of L-shaped positioning members for positioning said detachable frame member.

7. The integrated coral cultivation system as claimed in claim 2, wherein said shelf unit further includes four adjustment members respectively connected to bottom ends of said front vertical rods and said rear vertical rods for rotating and adjusting a horizontal state of said main frame.

8. The integrated coral cultivation system as claimed in claim 2, wherein said main frame further includes:
a plurality of left outer connecting rods extending in the width direction and connected between one of said front vertical rods and a corresponding one of said rear vertical rods;
a plurality of right outer connecting rods extending in the width direction and connected between the other one of said front vertical rods and a corresponding other one of said rear vertical rods; and
a plurality of inner connecting rods extending in the width direction, at least one of said inner connecting rods being connected between one of said front horizontal rods and a corresponding one of said rear horizontal rods.

9. The integrated coral cultivation system as claimed in claim 1, wherein said water tank unit further includes at least one production tank configured to raise to-be-produced corals, another one of said shelf panels being configured to support said at least one production tank, said water supply unit being further configured to supply the aquaculture water to said at least one production tank, said at least one water collecting pipe including a plurality of water collecting pipes correspondingly communicating with said at least one aquaculture tank and said at least one production tank.

10. The integrated coral cultivation system as claimed in claim 9, wherein said water tank unit further includes at least one overflow tank, and at least one egg collecting device accommodated in said at least one overflow tank and communicating with said at least one production tank for receiving the aquaculture water overflowing from said at least one production tank.

11. The integrated coral cultivation system as

10. in claim 10, wherein said at least one egg collecting device includes an egg collecting member, and a buffer member receiving and surrounding said egg collecting member.
